(19) United States
(12) Patent Application Publication
(10) Pub. No.: US 2016/0350703 A1
(43) Pub. Date: Dec. 1, 2016

(54) ELECTRONIC PRICE, INVENTORY MANAGEMENT AND LABEL SYSTEM

(71) Applicant: MariElla Labels Oy, Vantaa (FI)

(72) Inventors: Göran SUNDHOLM, Tuusula (FI); Jenni VIRNES, Helsinki (FI)

(73) Assignee: MariElla Labels Oy, Vantaa (FI)

(21) Appl. No.: 14/723,126

(22) Filed: May 27, 2015

(51) Int. Cl. G06Q 10/08; G06Q 30/02

(52) U.S. Cl. CPC G06Q 10/087; G06Q 30/0206

(57) ABSTRACT

A method for an electronic price, inventory management and label system and an electronic price, inventory management and label system which includes an electronic price label system and a product database in which products are listed. The electronic price, inventory management and label system has at least a first state and a second state for products listed in the product database. A specific product is linked to a specific electronic price label in the product database. The following steps are performed in the method: receiving a query request about status of the electronic price labels and/or the products linked to the electronic price labels, and sending information about the products which are in the first state and information about the products which are in the second state as a response to the received query request.

### FIELD OF THE INVENTION

The invention relates to electronic price, inventory management and label systems.

### BACKGROUND OF THE INVENTION

Conventionally, the price information on price tags in shops is always changed manually when the price of the product is changed. The new prices are printed out on paper or a corresponding material, and these tags with their new price markings are placed manually to the products in the sales premises. Thus, an employee must first find the correct product and the price tag to be updated, after which the new price tag is inserted in its position. A disadvantage in this arrangement is, among other things, the fact that the arrangement is very laborious and there is a high risk of mistakes. In case of a mistake, a situation may, for example, occur, in which the price information on the price tags on the products conflicts with the price information in the cash register system.

To avoid the above mentioned drawbacks, electronic systems have been developed, in which electronic labels and their electronic displays are attached to the products, in which the price information of the products can be changed in a centralized manner from the control centre of the system, or the like. This will facilitate and accelerate the updating of the price information to a significant extent.

Also Point-of-Sale (POS) systems are used in the retail environment. The POS-systems of the prior art are used in various retail situations and they are implemented with hardware and software tailored to their particular requirements. Retailers may utilize weighing scales, scanners, electronic and manual cash registers, EFTPOS terminals, touch screens and a variety of other hardware and software available. POS software may also include additional features to cater for different functionality, such as inventory management, CRM, financials, warehousing, etc.

It's also known to use inventory or stock control systems in retail environment. Typical features of stock control systems include e.g. ensuring that the products are on the shelf in shops in just the right quantity, recognizing when a customer has bought a product, signaling when more products need to be put on the shelf from the stockroom, reordering stock at the appropriate time from the main warehouse, producing management information reports that could be used both by the store and also at head office.

With above described prior art systems it's not possible to provide detailed information about the products and their statuses and e.g. information about which products are in the store and which products are outside the store e.g. in a warehouse.

### SUMMARY OF THE INVENTION

It is an aim of the present invention to reduce the above-mentioned problems and simultaneously provide an arrangement for an electronic price, inventory management and label system.

The method according to the invention is presented in claim 1 and the label system according to the invention is presented in claim 9. Other embodiments of the invention are characterized in what will be presented in the other claims.

The idea of the invention is to provide an electronic price, inventory management and label system, the electronic price, inventory management and label system comprising an electronic price label system and a product database in which products are listed. The electronic price, inventory management and label system has at least a first state and a second state for products listed in the product database. A specific product is linked to a specific electronic price label in the product database. The system is able to receive a query request about status of the electronic price label and/or the product linked to the electronic price label and as a response to the received query the system can send information about the products which are in the first state and information about the products which are in the second state.

In one embodiment of the invention in the first state the electronic price label linked to the product is in a deactivated state, and in the second state the electronic price label linked to the product is in an activated state, where the electronic price label can be remotely updated via radio based communication.

In one embodiment of the invention when the state of the electronic label is changed from the first state to the second state, the electronic label is activated to a state where it can be remotely updated via radio based communication

In one embodiment of the invention the information about the products which are in the first state is based on the information stored on the product database and/or the information about the products in the second state is based on real time status of the electronic price label queried via radio communication from the electronic price labels.

In one embodiment of the invention first state is used when the product is not at the store and second state is when the product is in the store.

With the solution of the current invention it's possible to have a system which is able to provide detailed information about the products and their statuses, e.g. which products are in the store and which products are outside the store, e.g. in warehouse and other statistic information related to the product.

In one embodiment of the invention system provides statistic information about the products such as how long time a product has been in the store, a list of products which have shortest rotation times, statistics about the alarms statistics about the waste level, statistics about the locations of the store where products are sold the best, i.e. shortest selling time based on location and/or comparison of products based on different criteria such as pieces sold per type and size, rotation time for different products, selling time of all different sizes, selling time of all different colors.

### DESCRIPTION OF THE DRAWINGS

In the following, the invention will be described in more detail by means of an embodiment example with reference to the appended drawings, in which

FIG. 1 shows an example implementation of an electronic price, inventory management and label system,

FIG. 2 shows a schematic and simplified view of an example arrangement of the electronic price label system in a store or in corresponding sales premises.

### DETAILED DESCRIPTION OF THE INVENTION

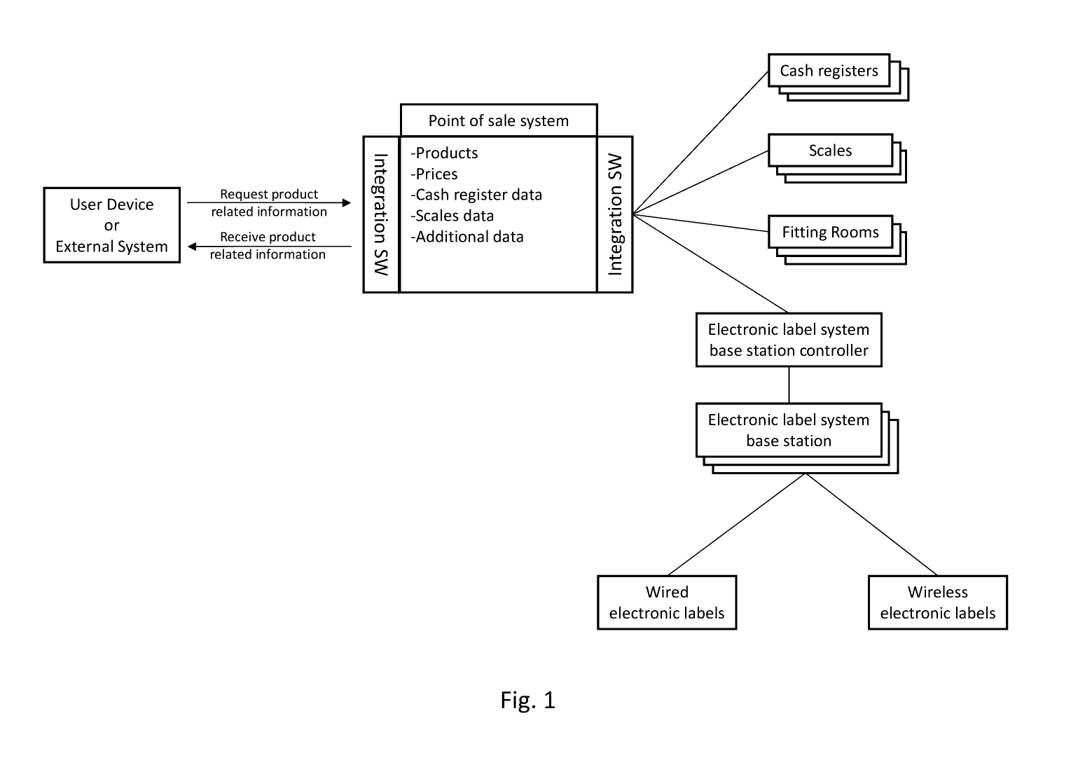

FIG. 1 presents an example implementation of the electronic price, inventory management and label system. The system comprises an electronic price label system and a product database in which products are listed (product database not shown in the FIG. 1). The electronic price, inventory management and label system can also comprise a point of sale system or be connected to a point of sale system.

Point of sale system is used to manage prices, stock, scales data, cash register data or other similar sale or product related data of a store. A user device can communicate with the point of sale system of a store through an interface. The point of sale system can be connected through an interface also to cash registers, scales and an electronic price label system. Trough the interface the point of sale system can e.g. update information on cash registers and scales or gather information on activities such as sales on the cash registers or scales.

The electronic price label system, connected to the point of sale system, can be used to change and present prices to the customers. The electronic price label system comprises electronic price label system base station controller, one or more base stations and one or more electronic price labels. Base stations of the electronic price label system are installed in stores and are typically connected in a wired manner, for example, via Ethernet connection to the base station controller. The base station controller is further connected to a store level server containing the price and other product information.

A specific product is linked to a specific electronic price label in the product database of the system. The electronic price, inventory management and label system has at least a first state and a second state for products listed in the product database. The states can be e.g. offline-state and online-state.

Products in the first state, e.g. offline-state, are products where the electronic price label has been linked to a product in the database level but these electronic labels have not yet been activated to be updated by the base stations of the electronic price label system. The connection or link of the product to the electronic price label is stored to a product database. Products in the offline-state can be e.g. in the store, in the warehouse, in distribution center or factory. The number of products in offline-state can be queried based on the information from the product database.

Products in the second state, e.g. online-state are products which have an active electronic price label which can be updated with the base station of the electronic price label system. The number of these products with activated price labels can be queried in real time and/or periodically via the electronic price label system.

When a user device or an external system wants to receive information about a certain product or plurality of products, the user device or external system requests information about the status of the electronic price labels and/or the products linked to the electronic price labels. The electronic price, inventory management and label system receives the query request about status of the electronic price labels and/or the products linked to the electronic price labels and sends information as a response about the products which are in the first state and information about the products which are in the second state as a response to the received query request. The electronic price, inventory management and label system can also send other information such as statistics related to a product, an electronic label related to a product and/or any other information such as other statistic information.

The electronic price, inventory management and label system can be scheduled to automatically make an inventory query of all the products in the store e.g. periodically for example every night. This way daily reliable inventory information of all products in the store and/or warehouse is available. This information is much more reliable than with the prior art systems where the inventory is usually manually checked once or twice the year.

The electronic price label can be linked to or paired with the product at any phase of manufacturing, transporting or storing the product. The transportation of the products or arrival of the products from the factory to the distribution center or from the distribution center to the warehouse or from the warehouse to the store can be confirmed by changing the state of the electronic price label from first state to second state. When the state is changed from the first state to the second state the electronic price label can be activated and the electronic price label system can begin, with a radio based query, to check the presence of the electronic price labels. As a result of the query the status and number of products with activated electronic price label can be found out. This information can be compared to the product database to see e.g. if the correct number of certain products were received.

With first state and second state, e.g. the online state/offline state, it can be quickly checked from the recently updated and/or real-time report if there are products in the store (products in the first state) or in case there are no specific products in the store, are there any those kind of products at the warehouse (products in the second state).

The electronic price, inventory management and label system can also report the number and/or type of products at the store (products in second state, e.g. with online state) and automatically recommend that products (in first state, e.g. with offline state) would be brought from the warehouse to the store if the number of products at the store is low.

The electronic price, inventory management and label system can be also used to recognize certain events or patterns, e.g. related to loss of products by comparing detected inventory information to the sales information. Because the inventory can be checked easily, e.g. every day and/or night, certain days can be recognized when there are more losses of products than on the average. Based on this information the reasons for the losses can be found out.

The regular and optionally periodical inventory query can be used check and report the sales of certain products. The model, size and/or color of the product can be recognized in the electronic price, inventory management and label system and based on this the system can create report of model, size and/or color of the products which are sold well and fast and model, size and/or color of the products which are not selling well.

If the products stay long in the store and are not selling well, the system can recommend dropping the price or the system can drop the price automatically based on predefined rules, e.g. such that if the product has been in the store for 3 weeks the price is lowered 10%, if the product has been in the store for 4 weeks the price is lowered 20%, etc. This reduces manual pricing work which is needed with the prior art systems. When price of a certain product is changed the price information will be changed in the electronic price label system and this information will be delivered through the base stations to individual electronic labels.

The electronic price, inventory management and label system can provide a list of the worst selling products and recommend price drops for the products. Then the store or store personnel can activate the recommended price drops for those products.

In one embodiment of the invention the system can also comprise fitting rooms with sensors able to monitor model, size, and/or color of the products brought to the fitting room. In this embodiment the number of sold products and time it takes to sell a product can be compared to information gathered about fitting the same products. In this way the system is able to report if certain products are being tried on in the fitting room by the customers but they are not sold for some reason.

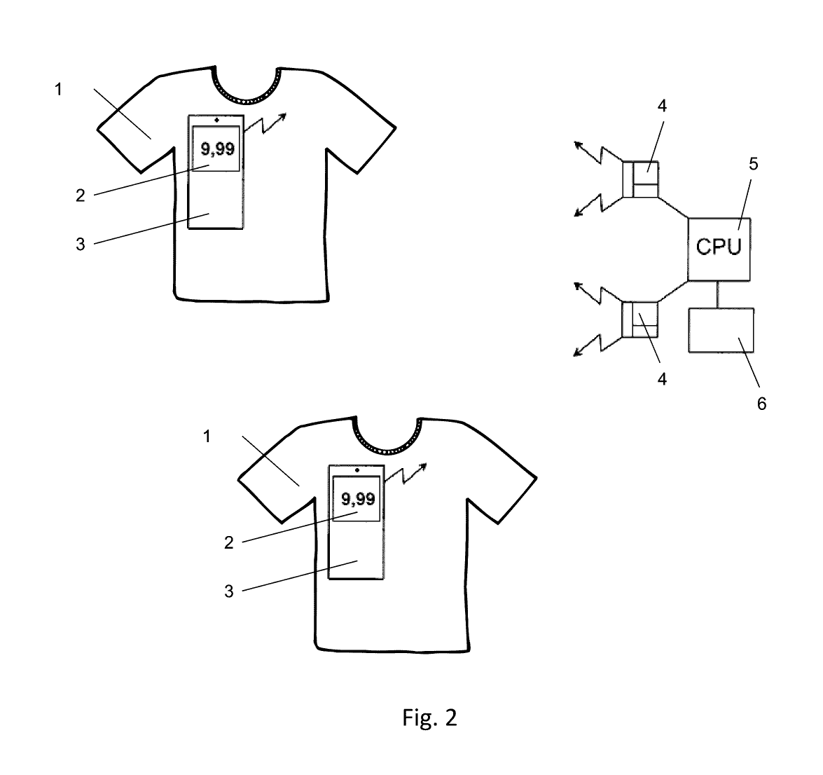

FIG. 2 shows schematically, as an example, a typical arrangement of the electronic price label system in a store or similar sale environment.

Products 1 are equipped with electronic labels 3 which comprise a display 2. The electronic labels 3 are typically attached to the products with different kind of fixing means. The display 2 is arranged to display the price of the product, and the product information contains, among other things, the name of the product and possibly some other information relating to the product. The electronic price label 3 can also have a separate indication marking, e.g. color-marking, which can indicate product related information such as a sale promotion for the product, sale promotion to regular customers for the product and/or a new product.

Each electronic display 2 can constitute a thin price tag equipped with display segments and/or pixels and resembling a paper price tag, in which the required product prices and other necessary symbols are formed by changing the color of the substantially two-colored or multi-colored display segments.

One layer of the display is, for example, an active ink layer. The ink layer contains a number of microcapsules filled with liquid and containing, for example, substantially black particles with a positive surface charge and substantially white particles with a negative surface charge, whose location in the microcapsules is controlled by an electric field so that at the desired display segments, the black particles are on top, wherein said display segments look black when viewed from above, and at the other display segments, the white particles are on top, wherein these display segments look white when viewed from above. The background of the display consists of the same microcapsules, wherein, for example, the price information can be displayed as dark numbers against a light background, or vice versa, if desired. Such a display used can be, for example, the electrophoretic microcapsule display laminate disclosed in Finnish patent application No. FI 20050192.

Furthermore, the electronic price label system comprises at least a central processing unit 5 connected to a base station 4 or other communication means, via which it is possible to transmit, for example, updated price information and other control information to the display 2. Furthermore, the system may comprise scanners 6 located at cash registers and connected to the cash register system, for scanning the price, wherein the cash register system and the electronic labels always have the same up-to-date information on the prices of the products. Furthermore, the central processing unit 5 may be coupled to other controlling and supporting systems, e.g. to a point of sale system of a store. The wireless connection between the central processing unit 5 and the electronic labels 3 is illustrated with arrows.

The electronic labels 3 can have multiple memory locations for the information, for example for price information. The electronic labels 3 can also comprise multiple different views stored in the memory locations i.e. different pages that include different information to be displayed.

The electronic labels 3 communicate in a wireless manner with the base station 4 shown in FIG. 2. This wireless communication method may be based on any known wireless communication technology, but in order to save battery life of the electronic labels 3, passive backscatter radio communication is preferred. In this approach the base stations 4 actively send radio signals and instead of answering with active radio transmission, the electronic labels 3 do not use a radio transmitter; instead, they answer by modulating the reflected power of the base station signal. The modulation is achieved, typically, by changing the load state of the antenna in the electronic labels 3, for example, by connecting and disconnecting the antenna between the ground and non-ground potential. This modulation of the backscattered signal allows for the electronic labels 3 to answer to the base stations and further to the store level server.

Each electronic label 3 can be identified by its own identification code that the electronic label 3 in question knows to listen for in the transmission from the base station 4. After receiving new information, instructions or commands from the store server via base station 4, the electronic label 3 can acknowledge the reception of these instructions by using the reflected backscattering modulated properly and timely for the store level server to identify that the response is coming from the electronic label 3 is question. To facilitate that the store server may have a certain listening period after a transmission directed to a certain electronic label 3 for giving the module possibility to answer during that time.

It is clear for a person skilled in the art that the software applications, communicational functions and other functions of the system described schematically in FIGS. 1 and 2 can be arranged in a wide variety of different ways depending on the details of the application in question. FIGS. 1 and 2 only aim to provide a high level illustration as an example to aid for understanding the benefits of the invention described here.

Although exemplary embodiments of the present invention have been described with reference to the attached drawings, the present invention is not limited to these embodiments, and it should be appreciated to those skilled in the art that a variety of modifications and changes can be made without departing from the spirit and scope of the present invention.

1. A method for an electronic price, inventory management and label system, the electronic price, inventory management and label system comprising an electronic price label system and a product database in which products are listed wherein
the electronic price, inventory management and label system has at least a first state and a second state for products listed in the product database,
a specific product is linked to a specific electronic price label in the product database, wherein in the method following steps are performed:
receiving a query request about status of the electronic price labels and/or the products linked to the electronic price labels, and
sending information about the products which are in the first state and information about the products which are in the second state as a response to the received query request.

2. A method according to claim 1, wherein in the first state the electronic price label linked to the product is in a deactivated state, and in the second state the electronic price label linked to the product is in an activated state, in which the electronic price label can be remotely updated via radio based communication.

3. A method according to claim 1, wherein when the state of the electronic label is changed from the first state to the second state, the electronic label is activated to an active state where it can be remotely updated via radio based communication.

4. A method according to claim 1, wherein the information about the products which are in the first state is based on the information stored on the product database and/or the information about the products in the second state is based on status of the electronic price label queried via radio communication from the electronic price labels.

5. A method according to claim 1, wherein the first state is used when the product is not at the store and the second state is when the product is in the store.

6. A method according to claim 1, wherein system provides statistic information about the products such as how long time has a product been in the store, a list of products which have shortest rotation times, statistics about the alarms, statistics about the waste level, statistics about the locations of the store where products are sold the best, shortest selling time based on location, and/or comparison of products based on different criteria such as pieces sold per type and size, rotation time for different products, selling time of all different sizes, selling time of all different colours.

7. A method according to claim 1, wherein the system provides a price amendment suggestion if a product has been in the store longer than a predefined time limit.

8. A method according to claim 1, wherein the system provides an alarm or notification if there are products which are in second state, e.g. no products in the store, but there are products in the first state, e.g. products in the warehouse.

9. An electronic price, inventory management and label system, the electronic price, inventory management and label system comprising an electronic price label system and a product database in which products are listed wherein
the electronic price, inventory management and label system is configured to have at least a first state and a second state for products listed in the product database, wherein a specific product is linked to a specific electronic price label in the product database, and
the system is configured to receive a query request about status of the electronic price label and/or the product linked to the electronic price label,
as a response to the received query the system is configured to send information about the products which are in the first state and information about the products which are in the second state.

10. An electronic price, inventory management and label system according to claim 9, wherein
in the first state the electronic price label linked to the product is in a deactivated state, and
in the second state the electronic price label linked to the product is in an activated state, where the electronic price label can be re-motely updated via radio based communication.

11. An electronic price, inventory management and label system according to claim 9, wherein when the state of the electronic label is changed from the first state to the second state, the system is configured to activate the electronic label to a state where it can be remotely updated via radio based communication.

12. An electronic price, inventory management and label system according to claim 9, wherein the system is configured to provide information about the products which are in the first state based on the information stored on the product database and/or the information about the products in the second state based on status of the electronic price label queried via radio communication from the electronic price labels.

13. An electronic price, inventory management and label system according to claim 9, wherein the system is configured to use the first state when the product is not at the store and second state is when the product is in the store.

14. An electronic price, inventory management and label system according to claim 9, wherein system is configured to provide statistic information about the products such as how long time has a product been in the store, a list of products which have shortest rotation times, statistics about the alarms, statistics about the waste level, statistics about the locations of the store where products are sold the best, shortest selling time based on location, and/or comparison of products based on different criteria such as pieces sold per type and size, rotation time for different products, selling time of all different sizes, selling time of all different colours.

15. An electronic price, inventory management and label system according to claim 9, wherein the system is configured to provide a price amendment suggestion if a product has been in the store longer than a predefined time limit.

16. An electronic price, inventory management and label system according to claim 9, wherein the system is arranged to provide an alarm or notification if there are products which are in second state, e.g. no products in the store, but there are products in the first state, e.g. products in the warehouse

17. An electronic price, inventory management and label system according to claim 9, wherein the electronic price label system comprises base station controller, at least one base station and plurality of electronic labels (3).

18. A method according to claim 2, wherein when the state of the electronic label is changed from the first state to the second state, the electronic label is activated to an active state where it can be remotely updated via radio based communication.

19. A method according to claim 2, wherein the information about the products which are in the first state is based on the information stored on the product database and/or the information about the products in the second state is based on status of the electronic price label queried via radio communication from the electronic price labels.

20. A method according to claim 3, wherein the information about the products which are in the first state is based on the information stored on the product database and/or the information about the products in the second state is based on status of the electronic price label queried via radio communication from the electronic price labels.
